(19) United States
(12) Patent Application Publication
(10) Pub. No.: US 2026/0050531 A1
(43) Pub. Date: Feb. 19, 2026

(54) MODEL EVALUATION METHOD, APPARATUS, ELECTRONIC DEVICE, AND COMPUTER PROGRAM PRODUCT

(71) Applicant: Beijing Volcano Engine Technology Co., Ltd., Beijing (CN)

(72) Inventors: Min LIAO, Beijing (CN); Yang ZHANG, Beijing (CN); Yao FU, Beijing (CN); Jialin MENG, Beijing (CN); Wuli LIU, Beijing (CN); Xiaoliang ZHANG, Beijing (CN); Boying LIU, Beijing (CN)

(21) Appl. No.: 19/300,534

(22) Filed: Aug. 14, 2025

(30) Foreign Application Priority Data
Aug. 15, 2024 (CN) 202411124729.X

(51) Int. Cl. G06F 11/34

(52) U.S. Cl. CPC G06F 11/3447

(57) ABSTRACT

Embodiments of the present disclosure relate to a model evaluation method and apparatus, an electronic device, and a computer program product. The method includes sending a request for executing a selected evaluation strategy based on a user input indicating a selection, from a plurality of evaluation strategies, of the evaluation strategy for evaluating a target model. In addition, the method further includes obtaining an execution result of the request, where the execution result includes at least an evaluation result of the target model.

### CROSS-REFERENCE TO RELATED APPLICATION(S)

This application claims priority to Chinese Application No. 202411124729.X filed in Aug. 15, 2024, the disclosure of which is incorporated herein by reference in its entity.

### FIELD

The present application relates to the field of computer technologies, and in particular, to a model evaluation method and apparatus, an electronic device, and a computer program product.

### BACKGROUND

The large model is trained with a large amount of data, has strong generalization capabilities and excellent performance, and can cope with complex tasks and diverse application scenarios. Moreover, the large model also shows great potential and application prospects in many fields, such as medicine, finance, and autonomous driving, which promotes the overall development and wide application of artificial intelligence technology, and becomes an important driving force for current scientific and technological innovation.

The large model is being increasingly widely used in various fields, and its performance and reliability directly affect practical application effects. Through model evaluation, performance differences of the large model in different application scenarios can be revealed and a basis can be provided for model optimization. Therefore, evaluation of the large model becomes especially important.

### SUMMARY

Embodiments of the present disclosure provide a model evaluation method and apparatus, an electronic device, a computer program product, and a medium.

According to a first aspect of the present disclosure, a model evaluation method is provided. The method includes sending a request for executing a selected evaluation strategy based on a user input indicating a selection, from a plurality of evaluation strategies, of the evaluation strategy for evaluating a target model, where the plurality of evaluation strategies are published on a strategy system, and the strategy system is configured to: create a strategy file of the evaluation strategy, where the strategy file is stored in a database; set a dependency required for executing the evaluation strategy; and publish the evaluation strategy to a strategy service in the strategy system. In addition, the method further includes obtaining an execution result of the request, where the execution result includes at least an evaluation result of the target model.

According to a second aspect of the present disclosure, a model evaluation apparatus is provided. The apparatus includes a request sending module configured to send a request for executing a selected evaluation strategy based on a user input indicating a selection, from a plurality of evaluation strategies, of the evaluation strategy for evaluating a target model, where the plurality of evaluation strategies are published on a strategy system, and the strategy system includes: a strategy creation module configured to create a strategy file of the evaluation strategy, where the strategy file is stored in a database; a dependency setup module configured to set a dependency required for executing the evaluation strategy; and a strategy publishing module configured to publish the evaluation strategy to a strategy service in the strategy system. In addition, the apparatus further includes a result obtaining module configured to obtain an execution result of the request, where the execution result includes at least an evaluation result of the target model.

According to a third aspect of the present disclosure, an electronic device is provided. The electronic device includes a processor and a memory coupled to the processor, and the memory has instructions stored therein, where the instructions, when executed by the processor, cause the electronic device to perform the method according to the first aspect.

In a fourth aspect of the present disclosure, a computer-readable storage medium is provided. The computer program product is tangibly stored on a non-transitory computer-readable medium and includes computer-executable instructions, where the computer-executable instructions, when executed, cause a computer to perform the steps of the method of the first aspect of the present disclosure.

In a fifth aspect of the present disclosure, a computer-readable storage medium is provided. The computer-readable storage medium has one or more computer instructions stored thereon, where the one or more computer instructions are executed by a processor to implement the method according to the first aspect.

The Summary section is intended to introduce a selection of concepts in a simplified form, which will be further described in the Detailed Description section below. The Summary section is not intended to identify key features or essential features of the claimed subject matter, nor is it intended to limit the scope of the claimed subject matter.

### BRIEF DESCRIPTION OF THE DRAWINGS

The above and other features, advantages, and aspects of the embodiments of the present disclosure will become more apparent when taken in conjunction with the drawings and with reference to the following detailed description. In the drawings, the same or similar reference numerals represent the same or similar elements, where:

FIG. 1 shows a schematic diagram of an example environment in which a device and/or a method according to an embodiment of the present disclosure may be implemented;

FIG. 2 shows a flowchart of a model evaluation method according to an embodiment of the present disclosure;

FIG. 3 shows a schematic diagram of the architecture of a model evaluation and strategy system according to an embodiment of the present disclosure;

FIG. 4A shows a flowchart of a process of publishing an evaluation strategy according to an embodiment of the present disclosure;

FIG. 4B shows a schematic diagram of a user interface for creating a function according to an embodiment of the present disclosure;

FIG. 4C shows a schematic diagram of object relationships of context objects according to an embodiment of the present disclosure;

FIG. 5A shows a flowchart of a process for executing model evaluation according to an embodiment of the present disclosure;

FIG. 5B shows a schematic diagram of a user interface for creating an evaluation task according to an embodiment of the present disclosure;

FIG. 5C shows a schematic diagram of an execution result of a policy request according to an embodiment of the present disclosure;

FIG. 6 shows a block diagram of a model evaluation apparatus according to an embodiment of the present disclosure; and

FIG. 7 shows a block diagram of an electronic device according to an embodiment of the present disclosure.

In all the drawings, the same or similar reference numerals represent the same or similar elements.

### DETAILED DESCRIPTION OF EMBODIMENTS

It may be understood that, before using the technical solutions disclosed in the embodiments of the present disclosure, the user should be informed of the type, usage scope, usage scenario, and the like of the personal information (such as voice) involved in the present disclosure in an appropriate manner in accordance with relevant laws and regulations and the user's authorization should be obtained.

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. Unless explicitly stated, terms such as “first” and “second” may refer to different or the same objects. Other explicit and implicit definitions may also be included below.

As mentioned above, the development of large models is getting faster and faster, and the evaluation requirements for large models are increasing. In the related art of large model evaluation, a user needs to develop an evaluation strategy for each model to be evaluated and deploy the evaluation strategy after the development is completed, which is inefficient. In addition, the large model usually requires multiple rounds of optimization and continuous updating, and this process is repeated every time the optimization and update are completed, which greatly affects the development and optimization efficiency of the large model.

To this end, an embodiment of the present disclosure provides a model evaluation solution. In this solution, a target model is evaluated by selecting an evaluation strategy from a plurality of evaluation strategies, and an evaluation system can provide many evaluation strategies for selection to meet model evaluation requirements in different cases. In this way, a request for executing the evaluation strategy can be sent to obtain a corresponding evaluation result, thereby completing evaluation of the target model. Therefore, according to the model evaluation solution provided in the embodiments of the present disclosure, model evaluation can be efficiently completed, the evaluation efficiency can be improved, the development cycle of the model can be shortened, the iteration of the model can be accelerated, and the difficulty of developing a model evaluation task can be reduced, so that more people can participate in the model evaluation process.

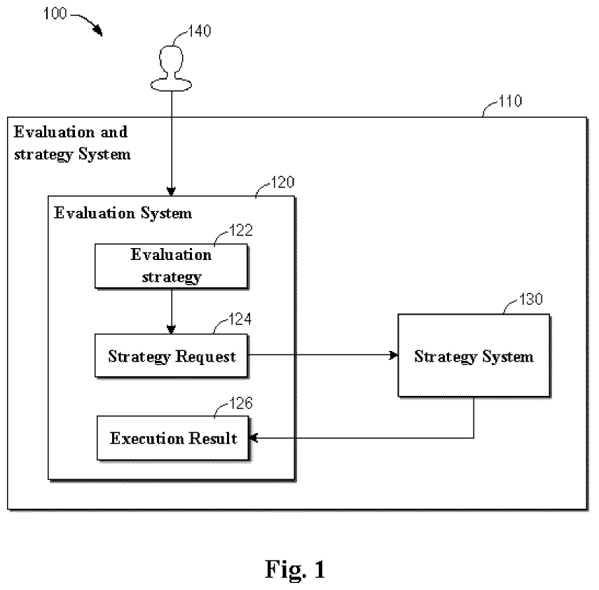

FIG. 1 shows a schematic diagram of an example environment in which a device and/or a method according to an embodiment of the present disclosure may be implemented. As shown in FIG. 1, the example environment 100 may include an evaluation and strategy system 110. The evaluation and strategy system 110 may include an evaluation system 120 and a strategy system 130. The evaluation system 120 may receive a user input 140, and the user input 140 may indicate a selection, from a plurality of evaluation strategies, of an evaluation strategy 122 for evaluating a target model. For example, the evaluation strategy 122 may include a to-be-evaluated target model, an evaluation dataset, a procedure for evaluating the target model, and the like. The evaluation system 120 may send a policy request 124 for executing the evaluation strategy 122 to the strategy system 130. For example, the policy request 124 may be a hypertext transfer protocol (HTTP) request.

The strategy system 130 may deploy a strategy service, and the strategy service may have a plurality of evaluation strategies. In some embodiments, the strategy service may be a function as a service (FaaS). When receiving the policy request 124, the strategy system 130 may trigger the FaaS service to execute the corresponding evaluation strategy. After executing the evaluation strategy 122, the strategy system 130 may transmit an execution result 126 to the evaluation system 120. The execution result 126 includes at least an evaluation result of the target model. For example, when evaluating the accuracy of the target model, the execution result 126 may include a measurement of the accuracy of the target model. In some embodiments, the execution result 126 may further include a model input, a model output, a ground truth, and an execution state for each evaluation data. In some embodiments, the content of the execution result 126 may be specified in the evaluation strategy 122.

It should be understood that the architecture and functions in the example environment 100 are described merely for the purpose of illustration, without implying any limitation to the scope of the present disclosure. The embodiments of the present disclosure may also be applied to other environments with different structures and/or functions.

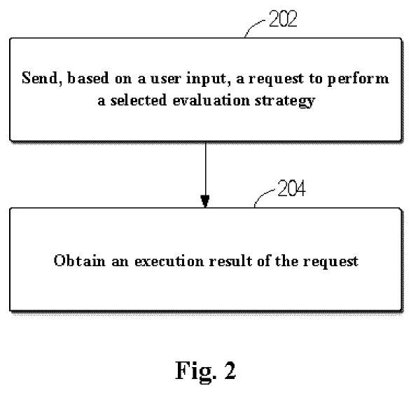

The processes according to the embodiments of the present disclosure will be described in detail below in conjunction with FIG. 2 to FIG. 7. For ease of understanding, specific data mentioned in the following description is exemplary and is not intended to limit the protection scope of the present disclosure. It may be understood that the embodiments described below may further include additional actions not shown and/or may omit the shown actions, and the scope of the present disclosure is not limited in this respect.

FIG. 2 shows a flowchart of a model evaluation method 200 according to an embodiment of the present disclosure. At block 202, a request for executing a selected evaluation strategy may be sent based on a user input indicating a selection, from a plurality of evaluation strategies, of the evaluation strategy for evaluating a target model. For example, referring to FIG. 1, the evaluation system 120 may receive the user input 140, and the user input 140 indicates the selection, from the plurality of evaluation strategies, of the evaluation strategy 122 for evaluating the target model. Then, the evaluation system 120 may send the request 124 for executing the selected evaluation strategy 122. The strategy system 130 may be configured to create a strategy file of the evaluation strategy 122 and store the strategy file in a database, and may also be configured to set a dependency required for executing the evaluation strategy 122 and publish the evaluation strategy 122 to a strategy service in the strategy system 130.

At block 204, an execution result of the request may be obtained, where the execution result includes at least an evaluation result of the target model. For example, referring to FIG. 1, the evaluation system 120 may obtain the execution result 126 of the request 124, where the execution result 126 includes at least the evaluation result of the target model.

Therefore, according to the method 200 in the embodiment of the present disclosure, the model evaluation can be efficiently completed, the evaluation efficiency can be improved, the development cycle of the model can be shortened, the iteration of the model can be accelerated, and the difficulty of developing a model evaluation task can be reduced, so that more people can participate in the model evaluation process.

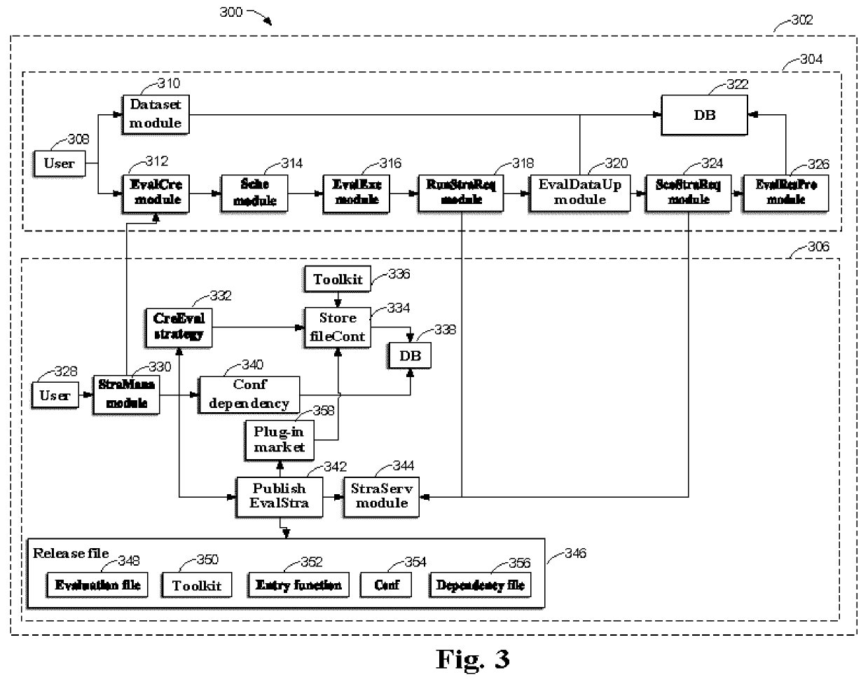

FIG. 3 shows a schematic diagram of the architecture 300 of a model evaluation and strategy system according to an embodiment of the present disclosure. As shown in FIG. 3, the model evaluation and strategy system 302 may include an evaluation system 304 and a strategy system 306. The evaluation system 304 may manage and execute model evaluation tasks, and the strategy system 306 may manage, deploy, and execute evaluation strategies. A user 308 may be a user with a large model evaluation requirement, and may include an administrator and a general user. A dataset module 310 may receive evaluation data uploaded by the user 308. For example, the evaluation data may include questions for evaluating the large model. In addition, the dataset module 310 may be configured to label the evaluation data, for example, correct answers, types, sources, and other information for each question in the evaluation data. In some embodiments, the original questions may be used to evaluate the large model, and the original questions may be updated during the evaluation process. In some embodiments, different evaluation tasks may use the same original questions. In some embodiments, different evaluation tasks may use different original questions.

An evaluation creation module 312 may receive a user input from the user 308 to select one or more evaluation strategies from a plurality of evaluation strategies. In some embodiments, the evaluation strategies may include a running strategy (also referred to as an API function) and a scoring strategy (also referred to as a scoring function). For example, when executing the large model evaluation, the API function may be executed first to complete each question in the evaluation data, and then the scoring function may be executed to generate the evaluation result of the large model. In some embodiments, the evaluation creation module 312 may receive the user's 308 selection of the running strategy and selection of the scoring strategy. For example, the user may specify the API function and the scoring function. In addition, the evaluation creation module 312 may further receive additional user selections. For example, the user 308 may select one or more large models to be evaluated, and may also select one or more evaluation datasets. The evaluation creation module 312 may create an evaluation task according to the user input, and then store the evaluation task to a scheduling module 314. The evaluation strategy is divided into the running strategy and the scoring strategy, so that the running strategy may be executed only once to obtain the output of the large model, and then different scoring strategies may be used to obtain different evaluation results, thereby avoiding repeated running of the large model and improving the evaluation efficiency.

In some embodiments, the scheduling module 314 may store one or more evaluation tasks. For example, when a plurality of users create a plurality of evaluation tasks, the scheduling module 314 may store the plurality of evaluation tasks and then schedule the evaluation tasks when the condition is satisfied. After the scheduling module 314 schedules the created evaluation task, the evaluation execution module 316 may execute the evaluation task. When the evaluation execution module 316 may execute the evaluation task, the running strategy request module 318 may send a request (for example, an HTTP request) for executing the API function. For example, the API function (i.e., the running strategy) may include obtaining a question in the evaluation data, obtaining prompt content, setting an answer to the question, obtaining a standard answer to the question, obtaining other front-end parameters, and the like. The running strategy request module 318 may send the request for executing the API function to a strategy service module 344 in the strategy system 306 to access the selected API function.

In some embodiments, the strategy service module 344 may be an FaaS service. The FaaS service is a cloud computing service, which allows users to write code in the form of functions and deploy the code to a cloud platform. The platform is responsible for managing the execution environment of the function, resource scheduling, expansion, and other tasks, while the user does not need to manage the underlying infrastructure but only needs to focus on the implementation of service logic. The embodiments of the present disclosure combine the large model evaluation with the FaaS service, which can implement an efficient and scalable evaluation process, reduce costs and maintenance difficulty, provide flexible and rapid iteration capabilities, and ensure the isolation and security of evaluation tasks, thereby improving the overall evaluation efficiency and accuracy.

The evaluation data update module 320 may receive the result of executing the API function from the strategy service module 344. For example, after the API function is executed, the execution result of the large model may be generated, and the evaluation data update module 320 may update the evaluation dataset based on the execution result of the large model and store the updated evaluation dataset in the database 322. For example, the execution results of different large models may be written into the evaluation dataset, and the name of the large model may be used as the field name of the corresponding execution result, so that differences between the execution results of different large models may be compared. The scoring strategy request module 324 may send a request for executing the scoring function (i.e., the scoring strategy) to the strategy service module 344, and the evaluation result processing module 326 may receive the result of executing the scoring function from the strategy service module 344 to obtain the evaluation result of the large model. The evaluation result processing module 326 may write the evaluation result of the large model into the database 322 and display the evaluation result on a user interface.

The strategy management module 330 in the strategy system 306 may receive a request for creating an evaluation strategy from a user 328. The user 328 may be the same user as or a different user from the user 308. For example, an evaluation strategy created by a user may be used by the user himself/herself or another user (for example, authorized) subsequently, and such reuse of evaluation strategies can significantly improve the evaluation efficiency of the large model. The strategy management module 330 may receive a user input to create the evaluation strategy 332, for example, a python file of an API function or a Policy may be created. The strategy management module 330 may perform saving the file content 334, for example, the file content of the evaluation strategy uploaded by the user, and a toolkit 336 provided by the strategy system 306 may be used in the strategy file. The toolkit 336 may support dataset management, environment variable calling, metadata acquisition, and the like, which can improve the efficiency of the user in writing the function file. Then, the file of the evaluation strategy may be stored in a database 338, such as a MySQL database. For example, the file of the evaluation strategy may be stored in a data table in the database 338, and the identifier key (i.e., the ID key) of the file in the data table may be used as an identification for external access.

The strategy management module 330 may be configured to perform configuring the dependency 340. For example, when writing the API function and the scoring function, a plurality of external dependencies are usually required, and the user 328 may conveniently add the dependencies through the strategy management module 330. In some embodiments, the required dependencies may be added into a dependency file, thereby implementing dependency isolation at the spatial level. For example, a dependency file “requirements.txt” may be used, and the required dependency packages (for example, specifying the names and version numbers of the dependency packages) may be added therein without the user separately installing and configuring the dependency packages, which is convenient for the user to use.

The strategy management module 330 may be configured to perform publishing the evaluation strategy 342, for example, publishing to the strategy service module 344. As mentioned above, the strategy service module 344 may be an FaaS service, and may also be another type of cloud computing service or event-driven service, which is not limited in the present disclosure. In some implementations, the published file 346 may include an evaluation file 348, a toolkit 350, an entry function 352, a service configuration file 354, and a dependency file 356. For example, the evaluation file 348 may be a file of the evaluation strategy obtained after the file content 334 is stored, and may be an API function file or a scoring function file; the toolkit 350 may be all or part of the toolkit 336; the entry function 352 may be used to route the entry of the evaluation file 348; the configuration file 348 may be a configuration file required by the strategy service module 344; and the dependency file 356 may be a dependency file generated after the dependency 340 is configured.

In addition, the strategy management module 330 may publish a functional function to a function plug-in market 358. The function plug-in market 358 may store a commonly used functional function and encapsulate it into a function plug-in. The functional function is a functional function that may be used when writing the API function or the scoring function. For example, the user 328 may encapsulate a functional function that compares whether two SQL queries are consistent into a function plug-in, and the function plug-in market 358 may publish the function plug-in. Then, when writing the API function or the scoring function, the user only needs to call the function plug-in. This process is similar to calling a local function, which is convenient for the user to write functions. For example, when the functional function is published in the function plug-in market 358, the strategy system 306 may provide a function plug-in list and provide template code for calling the function plug-in. In the process of writing the evaluation strategy, the function plug-in may be called like a local function by copying the template code.

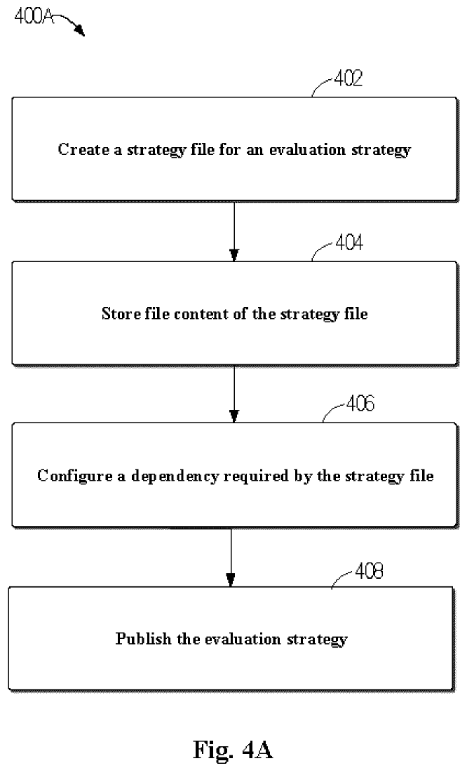

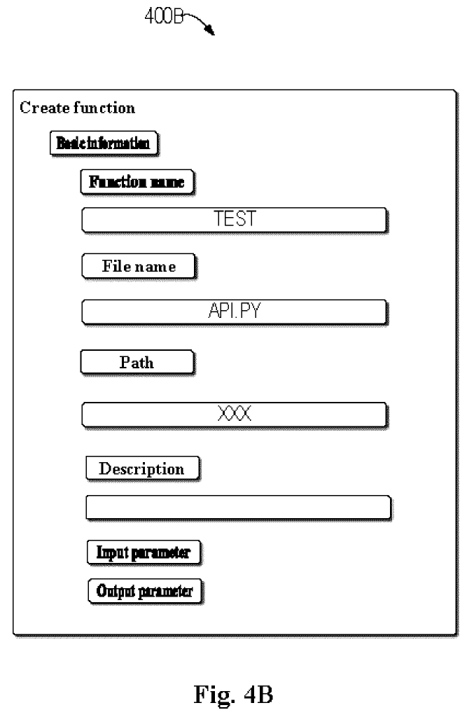

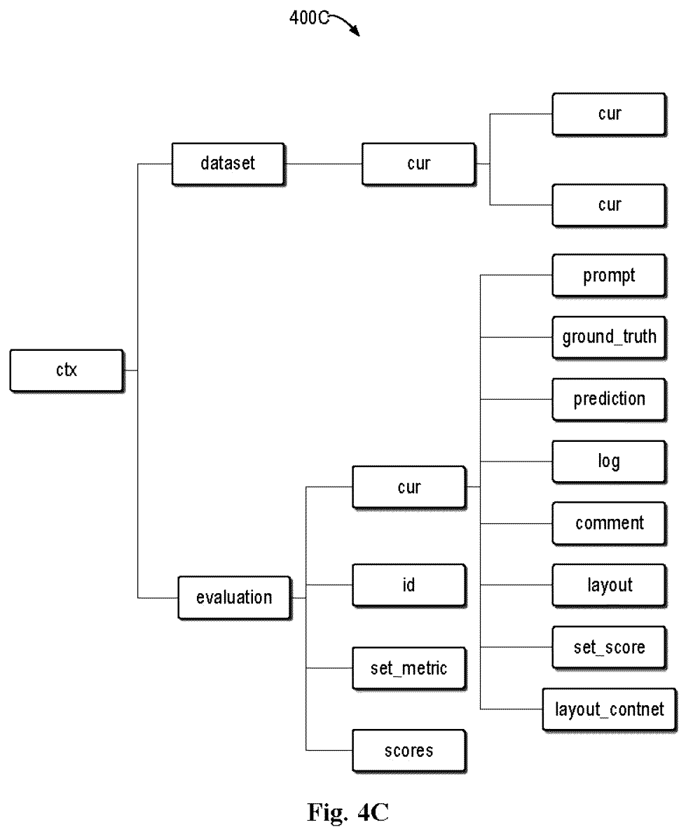

FIG. 4A shows a flowchart of a process 400A of publishing an evaluation strategy according to an embodiment of the present disclosure. For example, as described in conjunction with FIG. 3, the process of publishing the evaluation strategy may be executed on the strategy system 306 of the model evaluation and strategy system 302 as shown in FIG. 3. As shown in FIG. 4, at block 402, a strategy file of the evaluation strategy may be created. As mentioned above, the evaluation strategy is also referred to as an evaluation function, which may include a running strategy (also referred to as an API function) and a scoring strategy (also referred to as a scoring function). When executing the large model evaluation, the running strategy may be executed first to complete each question in the evaluation data, and then the scoring strategy may be executed to generate the evaluation result of the large model. It should be understood that the creation of the evaluation strategy described here includes creating the running strategy and creating the scoring strategy.

For example, after receiving a user input, the strategy system may create a function file in the user space where the user is located. In some embodiments, the user input includes basic information related to the creation of the evaluation function, such as a function name, a file name, a path, an incoming parameter, and an output parameter. In some embodiments, the created function file may be stored in a database (for example, the database 338 as shown in FIG. 3). For example, the created function file may be stored in a data table of a MySQL database, and the ID key is used as an identification for external access. FIG. 4B shows a schematic diagram of a user interface 400B for creating a function according to an embodiment of the present disclosure. As shown in FIG. 4B, the user may specify the basic information for creating the function, such as the function name, the file name, the path, the function description, the input parameter, and the output parameter.

Returning to FIG. 4A, at block 404, a file content of the strategy file may be stored. For example, the strategy file may include an API function file and a scoring function file. In some embodiments, the file content of the API function file may include an import part, a registration part, an information acquisition part, and a setup part, and the scoring function file may include a score setup part. For example, the import part may include, but is not limited to, a built-in library, dependencies included in a dependency file (for example, the dependency file 356 shown in FIG. 3), a toolkit, and a user-written function (supporting importing functions in other files). The registration part may include a decorator, and the decorator may register the function as a function that needs to be published. The information acquisition part may be configured to obtain relevant information (for example, a context object ctx) when the function is executed, receive an additional parameter (defined in an incoming parameter) defined by the function, obtain one row of data in the current dataset, obtain the current evaluation task, and the like.

The setup part may be configured to perform one or more of the following: modifying the dataset, for example, modifying a field name of the dataset; setting an answer, that is, setting a variable to store an execution result (i.e., a prediction result) of the large model, where the execution result may be stored in a database (for example, the database 322 shown in FIG. 3) and may be stored in a JSON format to facilitate subsequent parsing and processing; setting a log and a comment, where the log may be used to record information in the execution process of the API function, and the comment is used by the user to record the basis for scoring; setting a layout for display; and setting a score of the large model, for example, setting a score name, where the score name may be specified in the output parameter synchronously, and setting a group name, where the same group name will be displayed together when a plurality of scores are set, and a specific numerical value may be set, where the numerical value is set according to the requirements of the evaluation strategy. FIG. 4C shows a schematic diagram of object relationships 400C of context objects according to an embodiment of the present disclosure. When the above setup process is executed, one or more attributes or methods in the context object ctx object may be operated.

At block 406, the dependencies required by the strategy file may be configured. This process may be, for example, the process of configuring the dependency 340 executed by the strategy management module 330 in the strategy system 306 as shown in FIG. 3. For example, the dependency file may be obtained in the outermost directory of the project, and all the dependency packages required by the strategy file may be configured in the dependency file. In this way, it is only necessary to configure the dependencies required by the strategy file in the dependency file. When the system deploys or executes the policy function, the dependency file will be automatically read and all the dependency packages listed therein will be installed. The user does not need to manually install these dependency packages, thereby facilitating the user to evaluate the large model.

At block 408, the evaluation strategy may be published. For example, as described in conjunction with FIG. 3, the evaluation file 348, the toolkit 350, the entry function 352, the configuration file 354, and the dependency file 356 may be packaged as a published file, and the evaluation strategy may be published to the strategy service module 344 (for example, an FaaS service). For example, the strategy service module may provide an interface (for example, an HTTP interface) for accessing the FaaS service and an entry point (for example, an entry function) of the FaaS service for routing and calling the evaluation function written by the user. In this way, the evaluation strategy may be published to the FaaS service and called through the service interface, so that the evaluation strategy may run in an isolated, secure, and scalable environment.

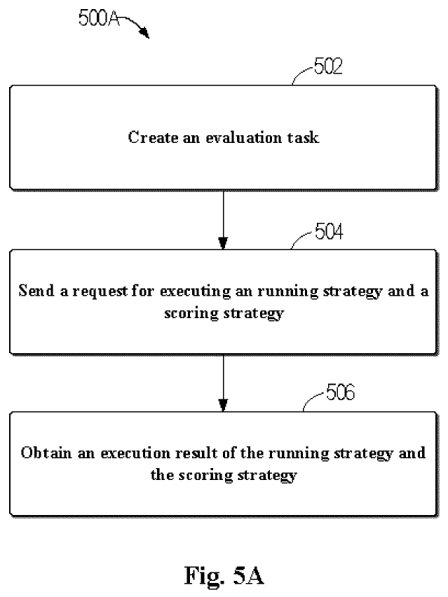

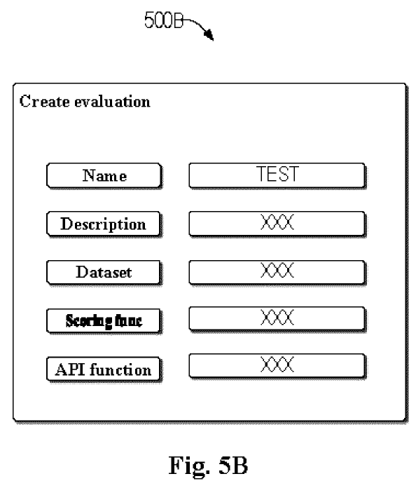

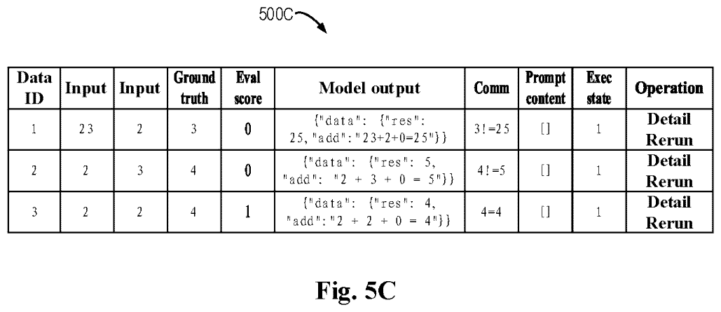

FIG. 5A shows a flowchart of a process 500A for executing model evaluation according to an embodiment of the present disclosure. For example, as described in conjunction with FIG. 3, the process of executing the model evaluation may be executed on the evaluation system 304 of the model evaluation and strategy system 302 as shown in FIG. 3. At block 502, an evaluation task of model evaluation may be created. For example, a user input may be received to create the evaluation task, and the user input may specify the execution of the evaluation strategy for executing the model evaluation. In some embodiments, the user input may specify a task name, an evaluation dataset, a running strategy (i.e., an API function), a scoring strategy (i.e., a scoring function), and the like. After the creation of the evaluation task is completed, the scheduling module may perform scheduling to execute the evaluation task. FIG. 5B shows a schematic diagram of a user interface 500B for creating an evaluation task according to an embodiment of the present disclosure. As shown in FIG. 5B, the user specifies the basic information for creating the evaluation task, such as the task name, the task description, the dataset, the scoring function, and the API function.

At block 504, a request for executing the running strategy and the scoring strategy may be sent. This process may be performed cyclically for each piece of data in the evaluation dataset. For example, as described in conjunction with FIG. 3, the running strategy execution module 318 may send a request for executing the running strategy to the strategy service module 344, and the scoring strategy request module 324 may send a request for executing the scoring strategy to the strategy service module 344. In some embodiments, an HTTP request may be sent to obtain a file path of the API function, a module where the API function is located may be obtained through the file path, and a context object (ctx object) required by the API function may be packaged. Then, the ctx object may be serialized, and the FaaS service may be accessed by sending the HTTP request. Then, when the strategy service module may distribute the request, for example, when the strategy service module receives the request, the entry function (for example, the entry function 352 as shown in FIG. 3) may be executed to distribute the request to the specified API function. For example, when the strategy service module distributes the request, the object in the request may be parsed to obtain the path of the ctx object and the module, and the ctx object may be deserialized. Then, a method including a decorator (for example, the registration part as shown in FIG. 4) may be obtained through Python reflection by loading the module path, so that the deserialized context object is transmitted to the function and the function is executed.

At block 506, execution results of the running strategy and the scoring strategy may be obtained. For example, the ctx object may be deserialized, and information such as a dataset field, a score, and a comment that need to be updated may be obtained in the deserialized ctx object. For example, as described in conjunction with FIG. 3, the evaluation data update module 320 may obtain the execution result of the running strategy, where the execution result of the running strategy may include the output of the large model; and the evaluation result processing module 326 may obtain the execution result of the scoring strategy, where the execution result of the scoring strategy may include the score, parameters, comments, and the like of the large model. For example, FIG. 5C shows a schematic diagram of an execution result 500C of a policy request according to an embodiment of the present disclosure. The execution result 500C shows information for each evaluation data, where the model output is the output of the large model running each evaluation data, and the evaluation score is the score for each evaluation data. The evaluation score of the large model may be generated by summarizing the scores for each evaluation data. In addition, the execution result also includes the ground truth and the execution state for each evaluation data.

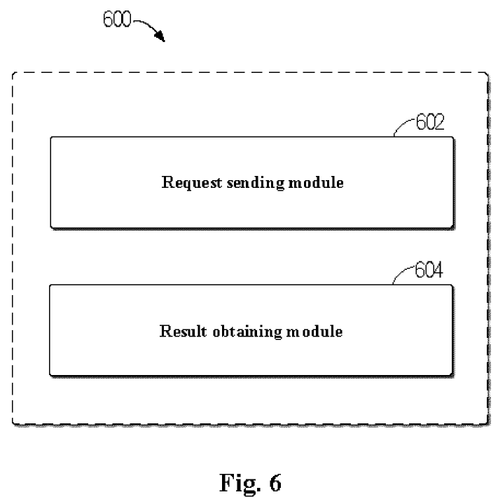

FIG. 6 shows a block diagram of a model evaluation apparatus 600 according to some embodiments of the present disclosure. As shown in FIG. 6, the apparatus 600 includes a request sending module 602 configured to send a request for executing a selected evaluation strategy based on a user input indicating a selection, from a plurality of evaluation strategies, of the evaluation strategy for evaluating a target model, where the plurality of evaluation strategies are published on a strategy system, and the strategy system includes: a strategy creation module configured to create a strategy file of the evaluation strategy, where the strategy file is stored in a database; a dependency setup module configured to set a dependency required for executing the evaluation strategy; and a strategy publishing module configured to publish the evaluation strategy to a strategy service in the strategy system. In addition, the apparatus further includes a result obtaining module 604 configured to obtain an execution result of the request, where the execution result includes at least an evaluation result of the target model.

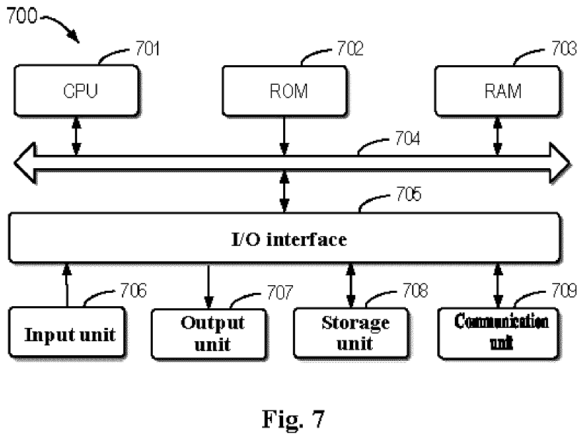

FIG. 7 shows a block diagram of an electronic device 700 according to some embodiments of the present disclosure. FIG. 7 shows a block diagram of an electronic device 700 according to some embodiments of the present disclosure. The device 700 may be the device or apparatus described in the embodiments of the present disclosure. As shown in FIG. 7, the device 700 includes a central processing unit (CPU) and/or a graphics processing unit (GPU) 701, which may perform various appropriate actions and processing according to computer program instructions stored in a read-only memory (ROM) 702 or computer program instructions loaded into a random access memory (RAM) 703 from a storage unit 708. In the RAM 703, various programs and data required for the operation of the device 700 may also be stored. The CPU/GPU 701, the ROM 702, and the RAM 703 are connected to each other through a bus 704. An input/output (I/O) interface 705 is also connected to the bus 704. Although not shown in FIG. 7, the device 700 may further include a coprocessor.

Multiple components in the device 700 are connected to the I/O interface 705, including: an input unit 706, such as a keyboard, a mouse, and the like; an output unit 707, such as various types of displays, speakers, and the like; a storage unit 708, such as a magnetic disk, an optical disk, and the like; and a communication unit 709, such as a network card, a modem, a wireless communication transceiver, and the like. The communication unit 709 allows the device 700 to exchange information/data with other devices through a computer network such as the Internet and/or various telecommunication networks.

The above-described various methods or processes may be executed by the CPU/GPU 701. For example, in some embodiments, the method may be implemented as a computer software program, which is tangibly contained in a machine-readable medium, for example, the storage unit 708. In some embodiments, part or all of the computer program may be loaded and/or installed on the device 700 via the ROM 702 and/or the communication unit 709. When the computer program is loaded into the RAM 703 and executed by the CPU/GPU 701, one or more steps or actions in the method or process described above may be executed.

In some embodiments, the method and process described above may be implemented as a computer program product. The computer program product may include a computer-readable storage medium loaded with computer-readable program instructions for executing various aspects of the present disclosure.

The computer-readable storage medium may be tangible device that can hold and store instructions used by the instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device, for example, a punched card or a groove protruding structure on which instructions are stored, and any suitable combination of the above. The computer-readable storage medium used here is not interpreted as a transient signal itself, such as a radio wave or other freely propagating electromagnetic wave, an electromagnetic wave propagating through a waveguide or other transmission medium (for example, an optical pulse through an optical fiber cable), or an electrical signal transmitted through a wire.

The computer-readable program instructions described herein may be downloaded from a computer-readable storage medium to various computing/processing devices or downloaded to an external computer or an external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or a network interface in each computing/processing device receives computer-readable program instructions from the network and forwards the computer-readable program instructions for storage in a computer-readable storage medium in the respective computing/processing device.

The computer program instructions used to perform the operations of the present disclosure may be assembly instructions, instruction set architecture (ISA) instructions, machine instructions, machine-related instructions, microcode, firmware instructions, state setup data, or source code or object code written in any combination of one or more programming languages, where the programming languages include an object-oriented programming language and a conventional procedural programming language. The computer-readable program instructions may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider). In some embodiments, the electronic circuit may be personalized and customized, for example, a programmable logic circuit, a field programmable gate array (FPGA), or a programmable logic array (PLA) by using state information of the computer-readable program instructions, where the electronic circuit can execute the computer-readable program instructions, thereby implementing various aspects of the present disclosure.

These computer-readable program instructions may be provided to a processing unit of a general-purpose computer, a special-purpose computer, or other programmable data processing apparatuses to produce a machine, so that the instructions, when executed by the processing unit of the computer or other programmable data processing apparatuses, produce an apparatus for implementing the functions/acts specified in one or more blocks in the flowcharts and/or block diagrams. These computer-readable program instructions may also be stored in a computer-readable storage medium. These instructions cause the computer, the programmable data processing apparatus, and/or other devices to work in a specific manner. Therefore, the computer-readable medium storing the instructions includes an article of manufacture, which includes instructions for implementing various aspects of the functions/acts specified in one or more blocks in the flowcharts and/or block diagrams.

These computer-readable program instructions may also be loaded onto a computer, other programmable data processing apparatuses, or other devices, so that a series of operation steps are performed on the computer, other programmable data processing apparatuses, or other devices to produce a computer-implemented process, so that the instructions executed on the computer, other programmable data processing apparatuses, or other devices implement the functions/acts specified in one or more blocks in the flowcharts and/or block diagrams.

The flowcharts and block diagrams in the drawings show possible architectures, functions, and operations of the device, method, and computer program product according to the embodiments of the present disclosure. In this regard, each block in the flowcharts or block diagrams may represent a part of a module, a program segment, or an instruction, where the part of the module, the program segment, or the instruction includes one or more executable instructions for implementing specified logical functions. In some alternative implementations, the functions marked in the blocks may also occur in a different order from those marked in the drawings. For example, two consecutive blocks may actually be executed substantially in parallel, or they may sometimes be executed in a reverse order, depending on the functions involved. It should also be noted that each block in the block diagrams and/or flowcharts and a combination of the blocks in the block diagrams and/or flowcharts may be implemented by a dedicated hardware-based system that performs the specified functions or acts, or may be implemented by a combination of dedicated hardware and computer instructions.

The embodiments of the present disclosure have been described above. The above description is exemplary and not exhaustive, and is not limited to the disclosed embodiments. Many modifications and changes will be apparent to those of ordinary skill in the art without departing from the scope and spirit of the described embodiments. The selection of terms used herein is intended to best explain the principles, practical applications, or technical improvements of the technologies in the market of the embodiments, or to enable other ordinary skilled in the art to understand the embodiments disclosed herein.

The following lists some example implementations of the present disclosure.

### Example 1

A model evaluation method, including:
based on a user input indicating a selection of an evaluation strategy for evaluating a target model from a plurality of evaluation strategies, sending a request for executing the selected evaluation strategy, where the plurality of evaluation strategies are published on a strategy system, and the strategy system is configured to: create a strategy file of the evaluation strategy, where the strategy file is stored in a database; set a dependency required for executing the evaluation strategy; and publish the evaluation strategy to a strategy service in the strategy system; and
obtaining an execution result of the request, where the execution result includes at least an evaluation result of the target model.

### Example 2

The method according to example 1, further including:
displaying the execution result, where the execution result further includes at least one of: a model input, a model output, a correct answer, and an execution state.

### Example 3

The method according to any one of examples 1 to 2, where the evaluation strategy includes a running strategy and a scoring strategy, and the receiving the user input includes:
receiving a first user input, where the first user input indicates a selection, from a plurality of running strategies, of the running strategy; and
receiving a second user input, where the second user input indicates a selection, from a plurality of scoring strategies, of the scoring strategy.

### Example 4

The method according to any one of examples 1 to 3, where the sending the request for executing the selected evaluation strategy includes:
sending a first request for executing the selected running strategy, where the running strategy is configured to generate a model output based on the target model; and
sending a second request for executing the selected scoring strategy, where the scoring strategy is configured to generate the evaluation result based on the model output.

### Example 5

The method according to any one of examples 1 to 4, where the obtaining the execution result of the request includes obtaining a first execution result of the first request, and the method further includes:
updating the evaluation dataset for evaluating the target model and the model output of the target model based on the first execution result.

### Example 6

The method according to any one of examples 1 to 5, where the obtaining the execution result of the request includes obtaining a second execution result of the second request, and the method further includes: updating the evaluation dataset for evaluating the target model and the evaluation score of the target model based on the second execution result.

### Example 7

The method according to any one of examples 1 to 6, where an identifier of the evaluation strategy is a key value of the strategy file in a data table of the database.

### Example 8

The method according to any one of examples 1 to 7, further including:
in response to detecting the request for executing the evaluation strategy, obtaining, by the strategy system, a context object for executing the evaluation strategy;
executing, by the strategy system, the evaluation strategy by transmitting the context object to the evaluation strategy; and
generating, by the strategy system, the execution result by executing the evaluation strategy.

### Example 9

The method according to any one of examples 1 to 8, where the dependency required for executing the evaluation strategy is specified in a dependency file, and the publishing the evaluation strategy to the strategy service in the strategy system includes:
publishing the strategy file, a toolkit for the strategy file, an entry function of the strategy file, a configuration file of the strategy service, and the dependency file in combination.

### Example 10

The method according to any one of examples 1 to 9, where the evaluation strategy includes a published functional function.

### Example 11

A model evaluation apparatus, including:
a request sending module configured to send a request for executing a selected evaluation strategy based on a user input indicating a selection, from a plurality of evaluation strategies, of the evaluation strategy for evaluating a target model, where the plurality of evaluation strategies are published on a strategy system, and the strategy system includes: a strategy creation module configured to create a strategy file of the evaluation strategy, where the strategy file is stored in a database; a dependency setup module configured to set a dependency required for executing the evaluation strategy; and a strategy publishing module configured to publish the evaluation strategy to a strategy service in the strategy system; and
a result obtaining module configured to obtain an execution result of the request, where the execution result includes at least an evaluation result of the target model.

### Example 12

The apparatus according to example 11, further including:
a result displaying module configured to display the execution result, where the execution result further includes at least one of: a model input, a model output, a correct answer, and an execution state.

### Example 13

The apparatus according to any one of examples 11 to 12, where the evaluation strategy includes a running strategy and a scoring strategy, and the input receiving module includes:
a first input receiving module configured to receive a first user input, where the first user input indicates a selection, from a plurality of running strategies, of the running strategy; and
a second input receiving module configured to receive a second user input, where the second user input indicates a selection, from a plurality of scoring strategies, of the scoring strategy.

### Example 14

The apparatus according to any one of examples 11 to 13, where the request sending module includes:
a first request sending module configured to send a first request for executing the selected running strategy, where the running strategy is configured to generate a model output based on the target model; and
a second request sending module configured to send a second request for executing the selected scoring strategy, where the scoring strategy is configured to generate the evaluation result based on the model output.

### Example 15

The apparatus according to any one of examples 11 to 14, where the result obtaining module includes a first result obtaining module configured to obtain a first execution result of the first request, and the apparatus further includes:
an evaluation data update module configured to update the evaluation dataset for evaluating the target model and the model output of the target model based on the first execution result.

### Example 16

The apparatus according to any one of examples 11 to 15, where the result obtaining module includes a second result obtaining module configured to obtain a second execution result of the second request, and the apparatus further includes:
an evaluation data second update module configured to update the evaluation dataset for evaluating the target model and the evaluation score of the target model based on the second execution result.

### Example 17

The apparatus according to any one of examples 11 to 16, where an identifier of the evaluation strategy is a key value of the strategy file in a data table of the database.

### Example 18

The apparatus according to any one of examples 11 to 17, further including:
a context object obtaining module configured to, in response to detecting the request for executing the evaluation strategy, obtain, by the strategy system, a context object for executing the evaluation strategy;
an evaluation strategy executing module configured to execute, by the strategy system, the evaluation strategy by transmitting the context object to the evaluation strategy; and
an evaluation result generating module configured to generate, by the strategy system, the execution result by executing the evaluation strategy.

### Example 19

The apparatus according to any one of examples 11 to 18, where the dependency required for executing the evaluation strategy is specified in a dependency file, and the publishing the evaluation strategy to the strategy service in the strategy system includes:
publishing the strategy file, a toolkit for the strategy file, an entry function of the strategy file, a configuration file of the strategy service, and the dependency file in combination.

### Example 20

The apparatus according to any one of examples 11 to 19, where the evaluation strategy includes a published functional function.

### Example 21

An electronic device, including:
a processor; and
a memory coupled to the processor, where the memory has instructions stored therein, where the instructions, when executed by the processor, cause the electronic device to perform acts, where the acts include:
sending a request for executing a selected evaluation strategy based on a user input indicating a selection, from a plurality of evaluation strategies, of the evaluation strategy for evaluating a target model, where the plurality of evaluation strategies are published on a strategy system, and the strategy system is configured to:
create a strategy file of the evaluation strategy, where the strategy file is stored in a database;
set a dependency required for executing the evaluation strategy; and
publish the evaluation strategy to a strategy service in the strategy system; and
obtaining an execution result of the request, where the execution result includes at least an evaluation result of the target model.

### Example 22

The electronic device according to example 21, further including:
displaying the execution result, where the execution result further includes at least one of: a model input, a model output, a correct answer, and an execution state.

### Example 23

The electronic device according to any one of examples 21 to 22, where the evaluation strategy includes a running strategy and a scoring strategy, and the receiving the user input includes:
receiving a first user input, where the first user input indicates a selection, from a plurality of running strategies, of the running strategy; and
receiving a second user input, where the second user input indicates a selection, from a plurality of scoring strategies, of the scoring strategy.

### Example 24

The electronic device according to any one of examples 21 to 23, where the sending the request for executing the selected evaluation strategy includes:
sending a first request for executing the selected running strategy, where the running strategy is configured to generate a model output based on the target model; and
sending a second request for executing the selected scoring strategy, where the scoring strategy is configured to generate the evaluation result based on the model output.

### Example 25

The electronic device according to any one of examples 21 to 24, where the obtaining the execution result of the request includes obtaining a first execution result of the first request, and the acts further include:
updating the evaluation dataset for evaluating the target model and the model output of the target model based on the first execution result.

### Example 26

The electronic device according to any one of examples 21 to 25, where the obtaining the execution result of the request includes obtaining a second execution result of the second request, and the acts further include:
updating the evaluation dataset for evaluating the target model and the evaluation score of the target model based on the second execution result.

### Example 27

The electronic device according to any one of examples 21 to 26, where the evaluation strategy has an identification that is a key value of the strategy file in a data table of the database.

### Example 28

The electronic device according to any one of examples 21 to 27, further including:
in response to detecting the request for executing the evaluation strategy, obtaining, by the strategy system, a context object for executing the evaluation strategy;
executing, by the strategy system, the evaluation strategy by transmitting the context object to the evaluation strategy; and
generating, by the strategy system, the execution result by executing the evaluation strategy.

### Example 29

The electronic device according to any one of examples 21 to 28, where the dependency required for executing the evaluation strategy is specified in a dependency file, and the publishing the evaluation strategy to the strategy service in the strategy system includes:
publishing the strategy file, a toolkit for the strategy file, an entry function of the strategy file, a configuration file of the strategy service, and the dependency file in combination.

### Example 30

The electronic device according to any one of examples 21 to 29, where the evaluation strategy includes a published functional function.

### Example 31

A computer-readable storage medium having one or more computer instructions stored thereon, where the one or more computer instructions are executed by a processor to implement the method according to any one of examples 1 to 10.

### Example 32

A computer program product tangibly stored on a computer-readable medium and including computer-executable instructions, where the computer-executable instructions, when executed by a device, cause the device to perform the method according to any one of examples 1 to 10.

Although the present disclosure has been described in language specific to structural features and/or logical actions of methods, it should be understood that the subject matter defined in the appended claims is not necessarily limited to the specific features or actions described above. On the contrary, the specific features and actions described above are merely example forms for implementing the claims.

I/We claim:

1. A method for model evaluation, comprising:
based on a user input indicating a selection of an evaluation strategy for evaluating a target model from a plurality of evaluation strategies, sending a request for executing the selected evaluation strategy, the plurality of evaluation strategies being published on a strategy system, and the strategy system being configured to:
create a strategy file of the evaluation strategy, wherein the strategy file is stored in a database;
set a dependency required for executing the evaluation strategy; and
publish the evaluation strategy to a strategy service in the strategy system; and
obtaining an execution result of the request, the execution result comprising at least an evaluation result of the target model.

2. The method according to claim 1, further comprising:
displaying the execution result, wherein the execution result further comprises at least one of: a model input, a model output, a correct answer, and an execution state.

3. The method according to claim 1, wherein the evaluation strategy comprises a running strategy and a scoring strategy, and receiving the user input comprises:
receiving a first user input, wherein the first user input indicates a selection, from a plurality of running strategies, of the running strategy; and
receiving a second user input, wherein the second user input indicates a selection, from a plurality of scoring strategies, of the scoring strategy.

4. The method according to claim 3, wherein sending the request for executing the selected evaluation strategy comprises:
sending a first request for executing the selected running strategy, wherein the running strategy is configured to generate a model output based on the target model; and
sending a second request for executing the selected scoring strategy, wherein the scoring strategy is configured to generate the evaluation result based on the model output.

5. The method according to claim 4, wherein obtaining the execution result of the request comprises obtaining a first execution result of the first request, and the method further comprises:
updating an evaluation dataset for evaluating the target model and the model output of the target model based on the first execution result.

6. The method according to claim 4, wherein obtaining the execution result of the request comprises obtaining a second execution result of the second request, and the method further comprises:
updating an evaluation dataset for evaluating the target model and an evaluation score of the target model based on the second execution result.

7. The method according to claim 1, wherein an identifier of the evaluation strategy is a key value of the strategy file in a data table of the database.

8. The method according to claim 7, further comprising:
in response to detecting the request for executing the evaluation strategy, obtaining, by the strategy system, a context object for executing the evaluation strategy;
executing, by the strategy system, the evaluation strategy by transmitting the context object to the evaluation strategy; and
generating, by the strategy system, the execution result by executing the evaluation strategy.

9. The method according to claim 8, wherein the dependency required for executing the evaluation strategy is specified in a dependency file, and publishing the evaluation strategy to the strategy service in the strategy system comprises:
publishing the strategy file, a toolkit for the strategy file, an entry function of the strategy file, a configuration file of the strategy service, and the dependency file in combination.

10. The method according to claim 8, wherein the evaluation strategy comprises a published functional function.

11. An electronic device, comprising:
a processor; and
a memory coupled to the processor, the memory having instructions stored therein, wherein the instructions, when executed by the processor, cause the electronic device to:
based on a user input indicating a selection of an evaluation strategy for evaluating a target model from a plurality of evaluation strategies, send a request for executing the selected evaluation strategy, the plurality of evaluation strategies being published on a strategy system, and the strategy system being configured to:
create a strategy file of the evaluation strategy, wherein the strategy file is stored in a database;
set a dependency required for executing the evaluation strategy; and
publish the evaluation strategy to a strategy service in the strategy system; and
obtain an execution result of the request, the execution result comprising at least an evaluation result of the target model.

12. The electronic device according to claim 11, the instructions further cause the electronic device to:
display the execution result, wherein the execution result further comprises at least one of: a model input, a model output, a correct answer, and an execution state.

13. The electronic device according to claim 11, wherein the evaluation strategy comprises a running strategy and a scoring strategy, and the instructions causing the electronic device to receive the user input further cause the electronic device to:
receive a first user input, wherein the first user input indicates a selection, from a plurality of running strategies, of the running strategy; and
receive a second user input, wherein the second user input indicates a selection, from a plurality of scoring strategies, of the scoring strategy.

14. The electronic device according to claim 13, wherein the instructions causing the electronic device to send the request for executing the selected evaluation strategy further cause the electronic device to:
send a first request for executing the selected running strategy, wherein the running strategy is configured to generate a model output based on the target model; and
send a second request for executing the selected scoring strategy, wherein the scoring strategy is configured to generate the evaluation result based on the model output.

15. The electronic device according to claim 14, wherein the instructions causing the electronic device to obtain the execution result of the request further cause the electronic device to obtain a first execution result of the first request, and the instructions further cause the electronic device to:
update an evaluation dataset for evaluating the target model and the model output of the target model based on the first execution result.

16. The electronic device according to claim 14, wherein the instructions causing the electronic device to obtain the execution result of the request further cause the electronic device to obtain a second execution result of the second request, and the instructions further cause the electronic device to:
update an evaluation dataset for evaluating the target model and an evaluation score of the target model based on the second execution result.

17. The electronic device according to claim 11, wherein an identifier of the evaluation strategy is a key value of the strategy file in a data table of the database.

18. The electronic device according to claim 17, the instructions further cause the electronic device to:
in response to detecting the request for executing the evaluation strategy, obtain, by the strategy system, a context object for executing the evaluation strategy;
execute, by the strategy system, the evaluation strategy by transmitting the context object to the evaluation strategy; and
generate, by the strategy system, the execution result by executing the evaluation strategy.

19. The electronic device according to claim 18, wherein the dependency required for executing the evaluation strategy is specified in a dependency file, and the instructions causing the electronic device to publish the evaluation strategy to the strategy service in the strategy system further cause the electronic device to:
publish the strategy file, a toolkit for the strategy file, an entry function of the strategy file, a configuration file of the strategy service, and the dependency file in combination.

20. A computer program product, the computer program product being tangibly stored on a non-transitory computer-readable medium and comprising computer-executable instructions, wherein the computer-executable instructions, when executed by a processor, cause the electronic device to:
based on a user input indicating a selection of an evaluation strategy for evaluating a target model from a plurality of evaluation strategies, send a request for executing the selected evaluation strategy, the plurality of evaluation strategies being published on a strategy system, and the strategy system being configured to:
create a strategy file of the evaluation strategy, wherein the strategy file is stored in a database;
set a dependency required for executing the evaluation strategy; and
publish the evaluation strategy to a strategy service in the strategy system; and
obtain an execution result of the request, the execution result comprising at least an evaluation result of the target model.
